(19) United States
(12) Patent Application Publication
(10) Pub. No.: US 2017/0315307 A1
(43) Pub. Date: Nov. 2, 2017

(54) OPTICAL SUB-ASSEMBLY FOR COMPACT OPTICAL INTERCONNECTIONS

(71) Applicant: Alliance Fiber Optic Products, Inc., Sunnyvale, CA (US)

(72) Inventors: Wei-Cheng Lee, New Taipei City (TW); Yen-Hsu Lin, New Taipei City (TW); Yao Li, Newark, CA (US)

(73) Assignee: Alliance Fiber Optic Products, Inc., Sunnyvale, CA (US)

(21) Appl. No.: 15/581,873

(22) Filed: Apr. 28, 2017

Related U.S. Application Data
(63) Continuation-in-part of application No. 15/140,489, filed on Apr. 28, 2016.

(51) Int. Cl. G02B 6/38

(52) U.S. Cl. CPC G02B 6/3874; G02B 6/3879; G02B 6/3825; G02B 6/3869

(57) ABSTRACT

An optical sub-assembly includes an optical adapter with a main body that defines an internal chamber disposed between a front side and a rear side. The internal chamber includes a rear internal chamber with a sleeve section and a rear body section. A connector is disposed within the rear internal chamber. The connector includes a ferrule, a ferrule holder and a rear body. A sleeve holding the ferrule and an optical fiber extending into the ferrule are included. The ferrule extends from the ferrule holder and the sleeve is disposed over the ferrule with an interference fit such that the ferrule, ferrule holder and sleeve form an integrated part. The sleeve is disposed in the sleeve section of the rear internal chamber of the main body with an interference fit such that the ferrule, ferrule holder, sleeve and rear body position and align the optical fiber within the optical adapter.

### CROSS-REFERENCE TO RELATED APPLICATIONS

The instant application is a continuation-in-part of U.S. patent application Ser. No. 15/140,489 filed on Apr. 28, 2016, which is incorporated herein in its entirety by reference.

### BACKGROUND

### Field

The disclosure relates generally to optical sub-assemblies and, more specifically, to optical sub-assemblies for compact optical interconnections.

### Technical Background

Optical fibers have seen increased use in a wide variety of electronics and telecommunication fields. The use of optical sub-assemblies to couple optical fibers to a wide variety of electronic devices, other optical fibers, etc., is known. Such optical sub-assemblies typically include an adapter with an internal chamber and a pair of connectors that rigidly position and optically align a pair optical fibers within the internal chamber of the adapter.

As the use of optical fibers continues to increase, the number of optical fibers and associated optical sub-assemblies placed and used within commercial and residential spaces also increases thereby increasing the demands on space requirements, ease of assembly and efficient packaging of optical sub-assemblies. Accordingly, optical sub-assemblies with a reduced size and a more efficient or simplistic design are desired.

### SUMMARY

One embodiment of an optical sub-assembly includes an optical adapter comprising a main body that defines an internal chamber disposed between a front side and a rear side. The internal chamber includes a rear internal chamber with a sleeve section and a rear body section. A connector is disposed within the rear internal chamber. The connector includes a ferrule, a ferrule holder and a rear body. A sleeve that holds the ferrule and an optical fiber that extends into the ferrule are included. The ferrule extends from the ferrule holder and the sleeve is disposed over the ferrule with an interference fit such that the ferrule, ferrule holder and sleeve form an integrated part. The sleeve is disposed in the sleeve section of the rear internal chamber of the main body with an interference fit and the ferrule holder is disposed in the rear body section of the rear internal chamber. The ferrule, ferrule holder, sleeve and rear body position and align the optical fiber within the optical adapter. In embodiments, the rear body is disposed within the rear body section of the rear internal chamber and has a rear face that is generally flush with the rear side of the main body. Also, the rear body may be a cap that covers a rear opening of the rear internal chamber. The rear internal chamber may include a transition section that extends between the sleeve section and the rear body section, and the ferrule holder may be disposed in the transition section and the rear body section. A locking mechanism may be included and be configured to lock the connector within the rear internal chamber of the optical adapter. The locking mechanism may include a locking mechanism slot disposed within a wall of the main body and a locking mechanism lever extending from the rear body. The locking mechanism lever engages the locking mechanism slot when the connector is disposed within the rear internal chamber of the optical adapter.

In another embodiment, an optical sub-assembly includes an optical adapter with a main body defining a front internal chamber and a rear internal chamber disposed between a front side and a rear side of the main body. A connector is disposed within the rear internal chamber. The connector includes a ferrule, a ferrule holder and a rear body. A sleeve is disposed within the rear internal chamber and an optical fiber extends through the rear body, ferrule holder and into the ferrule. The ferrule, ferrule holder and sleeve form an integrated part configured to position and align the optical fiber within the optical adapter. The rear body has a rear face generally flush with the rear side of the main body. The rear internal chamber includes a sleeve section, a rear body section and a transition section extending between the sleeve section and rear body section. The ferrule and the sleeve are disposed within the sleeve section with an interference fit and the rear body is disposed in the rear body section. The ferrule holder is disposed in the transition section. In embodiments, the optical adapter may include at least two front internal chambers and at least two rear internal chambers disposed between the front side and the rear side of the main body. In such embodiments, at least two connectors are included such that a connector comprising a ferrule, ferule holder, sleeve and rear body is disposed in each of the at least two rear internal chambers.

In yet another embodiment, an optical sub-assembly includes an optical adapter comprising a main body defining a first internal chamber and a second internal chamber disposed between a front side and a rear side. The first internal chamber and the second internal chamber each include a first rear internal chamber and a second rear internal chamber, respectively. A first connector is disposed within the first rear internal chamber and a second connector is disposed within the second rear internal chamber. The first connector and the second connector each include a ferrule, a ferrule holder, a rear body and a sleeve. A first optical fiber is disposed within the rear body, ferrule holder, and ferrule of the first connector, and a second optical fiber is disposed within the rear body, ferrule holder, and ferrule of the second connector. The ferrule, ferrule holder and sleeve of each of the first connector and the second connector form an integrated part disposed within the main body that positions and aligns the first optical fiber and the second optical fiber, respectively, within the optical adapter. The first rear internal chamber and the second rear internal chamber each comprise a sleeve section, a rear body section and a transition section extending between the sleeve section and the rear body section. The sleeves of the first connector and the second connector are disposed with an interference fit in the sleeve section of the first rear internal chamber and the second rear internal chamber, respectively. The rear bodies of the first connector and the second connector are disposed in the rear body sections of the first rear internal chamber and the second rear internal chamber, respectively. The ferrule holders of the first connector and the second connector are disposed in the transition sections and rear body sections of the first rear internal chamber and the second rear internal chamber, respectively. In embodiments, the rear bodies of the first connector and the second connector each include a ferrule holder cavity and the ferrule holders of the first connector and the second connector are disposed within the ferrule holder cavities of the rear bodies of the first connector and the second connector, respectively. The main body of the optical adapter may include at least two locking mechanism slots and the rear bodies of the first connector and the second connector each include a locking mechanism lever. The locking mechanism levers are engaged with the locking mechanism slots when the rear bodies of the first connector and the second connector are disposed within the first rear internal chamber and the second rear internal chamber, respectively.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a perspective exploded view of an optical sub-assembly according to one or more embodiments disclosed and described herein;

FIG. 2 is a cross-sectional view of section 2-2 in FIG. 1;

FIG. 3A is a cross-sectional exploded view of section 3A-3A in FIG. 1;

FIG. 3B is a cross-sectional view of a rear body in FIG. 1 according to one or more embodiments disclosed and described herein;

FIG. 3C is a cross-sectional view of a connector in FIG. 1 according to one or more embodiments disclosed and described herein;

FIG. 4 is a perspective view of the optical sub-assembly in FIG. 1 after being assembled;

FIG. 5 is a cross-sectional view of section 5-5 in FIG. 4;

FIG. 6 is a perspective exploded view of an optical sub-assembly according to one or more embodiments disclosed and described herein;

FIG. 7 is a cross-sectional view of the optical sub-assembly in FIG. 6 after being assembled;

FIG. 8 is a top view of an optical fiber loopback module with a prior art optical sub-assembly;

FIG. 9 is a top view of the optical fiber loopback module in FIG. 8 with an optical sub-assembly according to one or more embodiments disclosed and described herein; and

FIG. 10 is a top view of a rack module with a plurality of optical sub-assemblies according to one or more embodiments disclosed herein.

### DETAILED DESCRIPTION

Referring generally to the figures, various embodiments of an optical sub-assembly for coupling optical fibers to electronic devices, other optical fibers, etc., are shown. Generally, the optical sub-assembly includes an optical adapter and a connector. The optical adapter includes a main body that defines an internal chamber disposed between a front side and a rear side of the main body. The internal chamber includes a sleeve section and a rear body section. The connector may be disposed within the internal chamber and includes a ferrule, ferrule holder and a rear body. A sleeve disposed over the ferrule is included. The sleeve and rear body of the connector are complimentary in shape with the sleeve section and the rear body section, respectively, of the internal chamber of the optical adapter. The sleeve, ferrule, ferrule holder and rear body disposed within the internal chamber rigidly position and optically align the optical fiber within the optical adapter. As used herein, the term “rigidly position” refers to positioning the optical fiber within the optical adapter such that once the optical fiber is optically aligned with an electronic device or another optical fiber, the optical fiber maintains its optically aligned position unless removed from the optical adapter. As used herein, the term “optically aligned” refers to alignment of an optical fiber within the internal chamber of the optical adapter such that an optical signal from the optical fiber is transmitted and received by an electronic device or another optical fiber disposed in the internal chamber of the optical adapter with less than 10% optical signal loss.

As discussed in more detail below, the connector may not include a housing and such a simplified structure reduces the complexity and space needed to couple optical fibers to a wide variety of devices, for example various electronic devices, other optical fibers, etc.

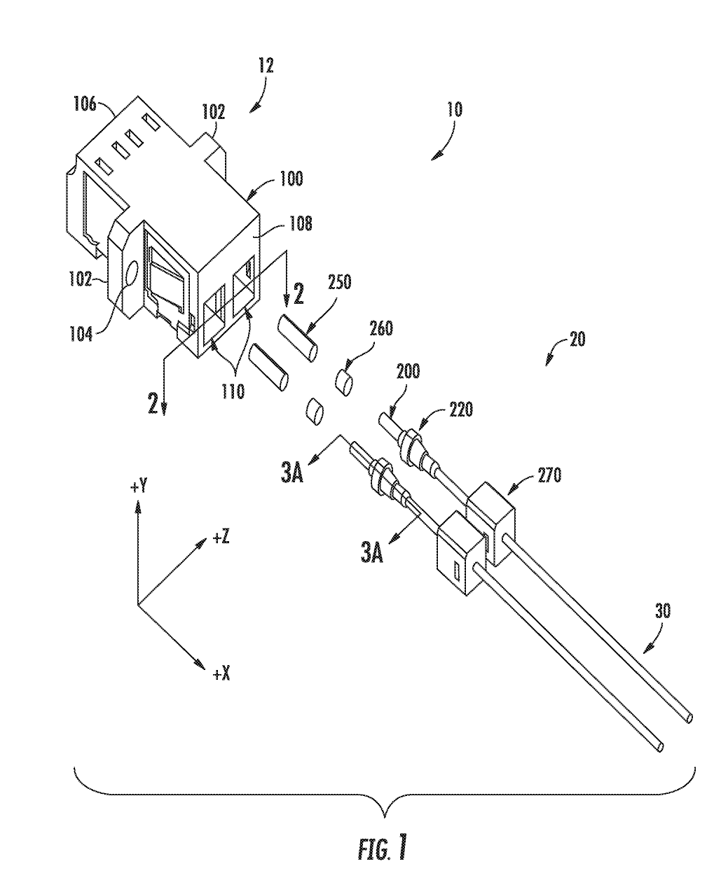

Referring to FIG. 1, an optical sub-assembly 10 according to the present disclosure may comprise an optical adapter 12 and a connector 20. As used herein, the term “optical sub-assembly” refers to an optical adapter and connector that provides for the coupling at least one optical fiber to an electronic device or another optical fiber. The optical adapter 12 includes a main body 100 with a front side 106 and a rear side 108. The main body 100 defines an internal chamber 110 between the front side and rear side 108. One or more flanges 102 with a hole 104 may extend from the main body 100 such that the optical adapter 12 can be mounted to a separate structure such as a module (not shown). The connector 20 includes a ferrule 200, a ferrule holder 220 and a rear body 270. An optical fiber 30 can extend through the rear body 270, the ferrule holder 220 and into the ferrule 200. A sleeve 250 may be included, as can a ring 260. In embodiments, the sleeve 250 is considered as part of the connector 20. e.g., the sleeve 250 is disposed over the ferrule 200 before the connector 20 is disposed within the internal chamber 110. In other embodiments, the sleeve 250 is not considered as part of the connector 20, e.g., the sleeve 250 is disposed within the internal chamber 110 before the connector 20 with the ferrule 200 is disposed within the internal chamber 110.

It should be appreciated that while FIG. 1 depicts the main body with two internal chambers 110 and two connectors 20 comprising the ferrule 200, ferrule holder 220 and rear body 270, the disclosure includes optical sub-assemblies with a single internal chamber 110 and connector 20 and optical sub-assemblies with more than two internal chambers 110 and connectors 20.

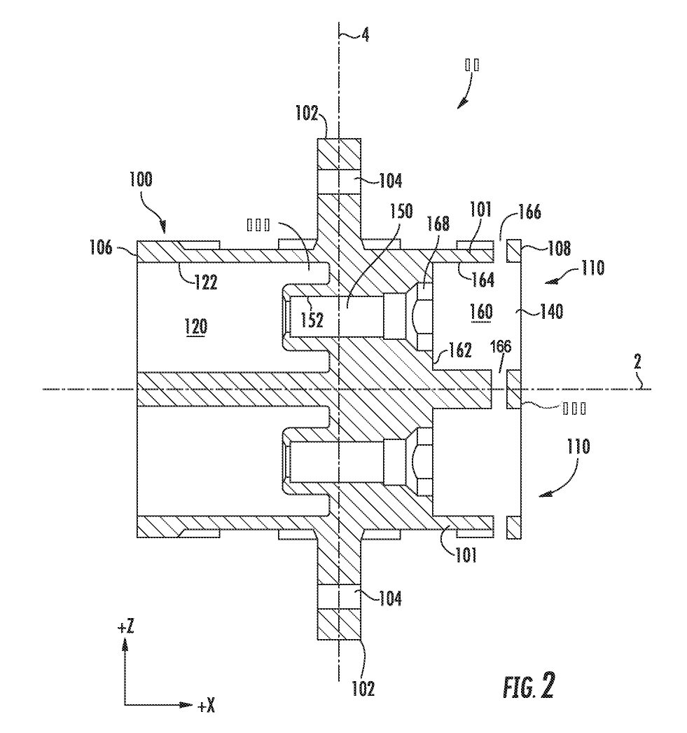

Referring to FIG. 2, a cross-sectional view of section 2-2 in FIG. 1 is shown. The optical adapter 12 includes the main body 100 with the internal chamber 110 disposed between the front side 106 and the rear side 108 of the main body 100. Although a pair of internal chambers 110 are shown in FIG. 2, e.g., a first internal chamber and a second internal chamber, only one of the internal chambers 110 is described below. The internal chamber 110 may include a front internal chamber 120 and a rear internal chamber 140. The rear internal chamber 140 may include a sleeve section 150 with a sleeve section inner surface 152 and a rear body section 160 with a front face 162 and a rear body section inner surface 164. A transition section 168 may be included and extend between the sleeve section 150 and the rear body section 160. A locking mechanism slot 166 may be disposed within a main body wall 101. In embodiments, a pair of locking mechanism slots are included with one of the locking mechanism lost 166 disposed within the main body wall 101 and another of the locking mechanism slots disposed within an interior wall 105. The front internal chamber 120 has a front internal chamber inner surface 122 and may include an alignment groove 124 for an electronic device (not shown) or other connector (not shown) disposed within the front internal chamber 120 to align with the optical fiber 30 disposed within the rear internal chamber 140. As depicted in FIG. 2, the main body 100 may include two front internal chambers 120 symmetrically disposed along a longitudinal axis 2. While FIG. 2 depicts the front internal chamber 120 having a different shape than the rear internal chamber 140, it should be appreciated that the optical adapter 12 may include a front internal chamber 120 that is symmetric with the rear internal chamber 140 about a transverse axis 4.

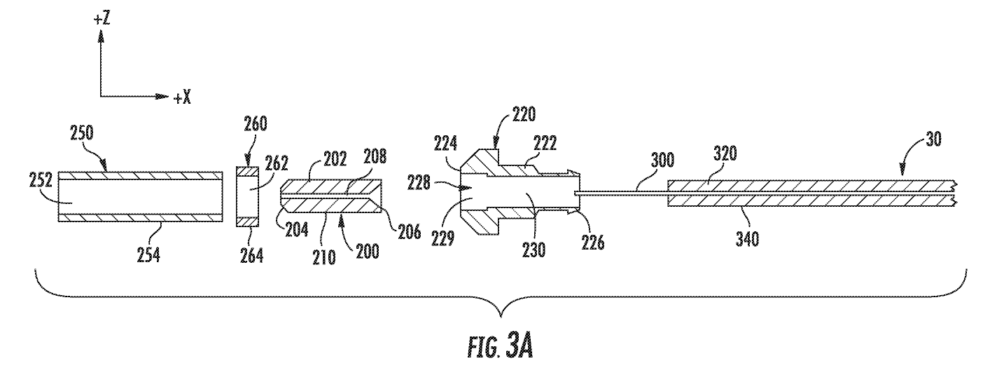

Referring to FIG. 3A, a cross-sectional exploded view of section 3A-3A in FIG. 2 is shown. The ferrule 200 includes a body 202. In the embodiment shown, body 202 is a substantially cylindrical body including a front face 204 at a front end and a rear face 206 at a rear end. A fiber receiving passage, shown as central bore 208, extends through body 202 between the front face 204 and rear face 206. Generally, the central bore 208 has a diameter that allows a core 300 of the optical fiber 30 to slide therewithin and be held in a fixed position relative to the body 202. The optical fiber may include a coating 320 and an outer jacket 340.

The ferrule holder 220 includes a body 222 with a front end 224 and a rear end 226. An internal passage 228 includes a ferrule portion 229 and an optical fiber portion 230. Generally, the ferrule portion 229 has an inner diameter that allows the ferrule 200 to be received therein and held in a fixed position relative to the body 222, and the optical fiber portion 230 has an inner diameter that allows the optical fiber 30 to slide therewithin. In some embodiments, the inner diameter of the ferrule portion 229 provides an interference fit between the ferrule 200 and ferrule holder 220 when the ferrule 200 slides within the ferrule portion 229. The interference fit allows an integrated part comprising the ferrule 200 and ferrule holder 220 to be formed. As used herein, the term “interference fit” refers to coupling between two parts achieved by friction after the parts are pushed together, and the term “integrated part” refers to at least two parts assembled together to form an assembly of parts that can be handled as a single part by an individual. In other embodiments, for example, an integrated part comprising the ferrule 200 and ferrule holder 220 may be formed without an interference fit, such as by overmolding the ferrule holder 220 onto the ferrule 200. That is, although FIG. 3A depicts the ferrule 200 and ferrule holder 220 as separate parts, it should be appreciated that the ferrule holder 220 may be overmolded onto the ferrule 200 to provide the ferrule 200 and ferrule holder 220 as a single part. As used herein, the term “overmolded” or “overmolding” refers to the ferrule holder molded onto a portion of the ferrule. Reference is made to US Patent Application Publication No. 2011/0158592 for examples, embodiments and teachings of ferrules, ferrule holders and ferrule holders overmolded onto ferrules, such examples, embodiments and teachings incorporated herein in by reference.

The sleeve 250 has an outer wall 254 with an internal opening 252 extending along a length (X direction in the figure) of the sleeve 250. In the embodiment shown, the sleeve 250 is a substantially cylindrical body with the outer wall 254 having an inner diameter such that the sleeve 250 can be disposed around the ferrule 200. In embodiments, the inner diameter of the outer wall 254 provides an interference fit between the sleeve 250 and the ferrule 200 such that an integrated part comprising the ferrule 200 and the sleeve 250 may be formed. In embodiments where the ferrule 200 is an integrated part with the ferrule holder 220, the sleeve 250 disposed on the ferrule 200 may provide an integrated part comprising the ferrule 200, ferrule holder 220 and sleeve 250 to be formed. A ring 260 may be included with an outer wall 264 and an inner opening 262. The outer wall 264 has an inner diameter that allows for the ring 260 to be disposed around the ferrule 200 and further integrate the ferrule 200 with the ferrule holder 220 and sleeve 250.

Referring to FIG. 3B, a cross-sectional view of the rear body 270 is shown. The rear body 270 has a front face 274 and a rear face 276. The rear body 270 defines a ferrule holder cavity 280 and an optical fiber opening 284 extending between the front face 274 and the rear face 276. The ferrule holder cavity 280 has an inner surface 282 and the optical fiber opening 284 has an inner surface 286. The ferrule holder cavity 280 and the optical fiber opening 284 may be generally cylindrically shaped with an inner diameter of the inner surface 282 allowing the ferrule holder 220 to slide therewithin and an inner diameter of the inner surface 286 allowing the optical fiber 30 to slide therewithin. In embodiments, the inner diameter of the inner surface 282 of the ferrule holder cavity 280 provides an interference fit between the rear body 270 and the ferrule holder 220. A locking mechanism lever 288 may be included and extend outwardly from an outer surface 272 of the rear body. In embodiments, the locking mechanism lever 288 is elastic or spring loaded such that the locking mechanism lever 288 can move inwardly (−Z direction)) and outwardly (+Z direction) relative to the outer surface 272 of the rear body 270.

Referring to FIG. 3C, an integrated part 290 formed from an assembly of the ferrule 200, ferrule holder 220, sleeve 250 and ring 260 is shown. The ferrule 200 is coupled to the ferrule holder 220 with a portion of the ferrule 200 disposed within the ferrule portion 229 of the ferrule holder 220. As mentioned above, in embodiments the inner diameter of the ferrule portion 229 may provide an interference fit between the ferrule 200 and the ferrule holder 220. In other embodiments, the ferrule holder 220 may be overmolded onto the ferrule 200. The sleeve 250 is coupled to the ferrule 200 with a portion of the sleeve 250 disposed around the ferrule 200. In embodiments, the inner diameter of the sleeve 250 provides an interference fit between the ferrule 200 and sleeve 250. Positioned between the front end 224 of the ferrule holder 220 (FIG. 3A) and the sleeve 250 is the ring 260. While FIG. 3C depicts the ring 260 disposed onto the ferrule 200, it should be understood that in some embodiments the integrated part 290 does not include the ring 260. i.e., the ring 260 may be optional to the integrated part 290 comprising the ferrule 200, ferrule holder 220 and sleeve 250.

Still referring to FIG. 3C, the optical fiber 30 extends through the optical fiber opening 284 (FIG. 3B) of the rear body 270 and is disposed within the ferrule holder 220 with the core 300 of the optical fiber 30 extending into the central bore 208 (FIG. 3A) of the ferrule 200. In embodiments, the core 300 is coupled to the ferrule 200 and ferrule holder 220 such that the core 300 is integrated with the integrated part 290.

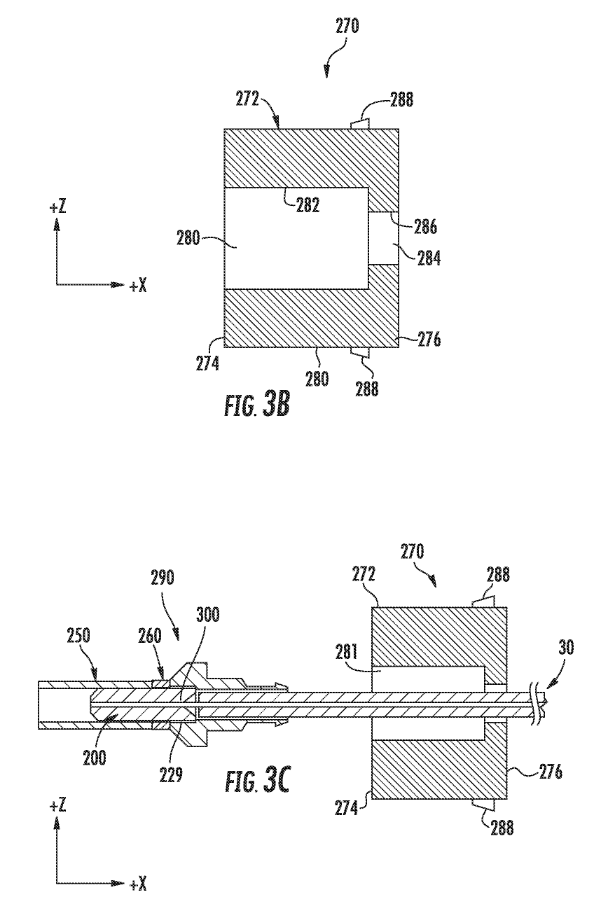

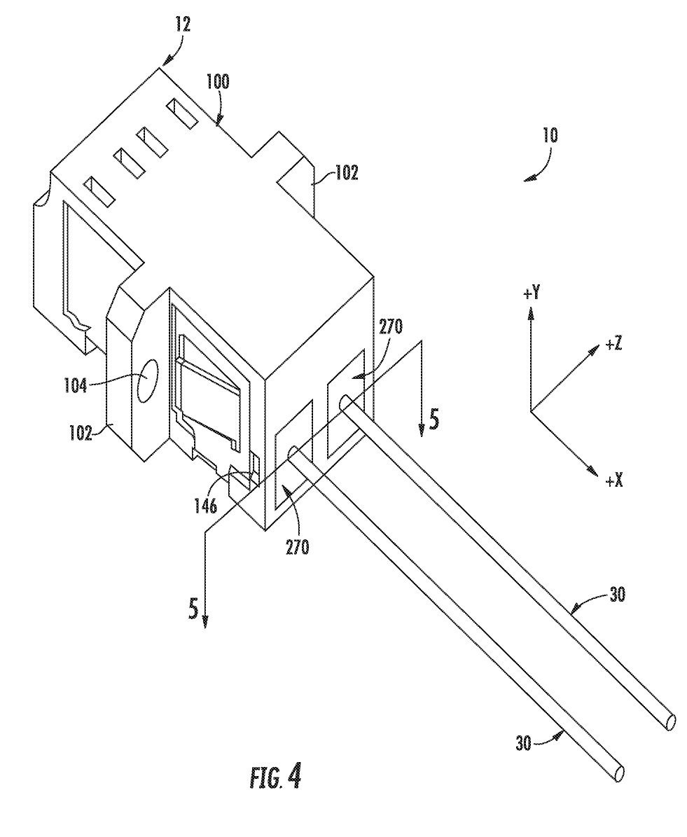

Referring now to FIGS. 4 and 5, a perspective view of the optical sub-assembly 10 (assembled) is shown in FIG. 4 and a cross-sectional view of section 5-5 in FIG. 4 is shown in FIG. 5. A ferrule 200, ferrule holder 220, sleeve 250 and rear body 270 are disposed within each of the internal chambers 110 of the optical adapter 12. Particularly, a ferrule 200, ferrule holder 220, sleeve 250 and rear body 270 are disposed within each of the rear internal chambers 140 (FIG. 2) of the optical adapter 12. Each sleeve 250 is disposed within a sleeve section 150 and each rear body 270 is disposed within a rear body section 160. Each ferrule holder 220 is disposed within a transition section 168 (FIG. 2) and extends into the rear body section 160. Each rear body 270 is disposed in a rear body section 160 and around a portion of a ferrule holder 220. Each ferrule 200 is disposed within a sleeve section 150 and a transition section 168. That is, each ferrule 200 is disposed in both a sleeve 250, which is disposed in a sleeve section 150, and in a ferrule portion 229 of a ferrule holder 220, which is disposed in a transition section 168. In embodiments where the ring 260 is disposed around the ferrule 200, each ring 260 is disposed within a sleeve section 150.

Still referring to FIGS. 4 and 5, each rear body 270 is disposed within a rear body section 160. In embodiments, the front face 274 of each rear body 270 abuts against the front face 162 of the rear body section 160 and the rear face 276 of the each rear body 270 is generally flush with the rear side 108 of the main body 100. That is, a length (X direction in the figures) of the rear body 270 is generally equal to a depth (X direction in the figures) of the rear body section 160 such that the rear body 270 generally fits within the rear body section 160 and does not extend beyond (+X direction) the rear side 108 of the main body 100. As used herein, the term “flush” refers to two surfaces being generally co-planar with each other. In other embodiments, the rear face 276 of the each rear body 270 is a cap that covers the rear body section 160 as depicted in FIG. 4. In still other embodiments, the rear face 276 of each the rear body 270 is generally flush with the rear side 108 of the main body and is a cap that covers the rear body section 160.

Referring particularly to FIG. 5, the integrated part 290 (FIG. 3C) the core 300 of the optical fiber 30 is rigidly positioned within the sleeve section 150 of the rear internal chamber 140. It should be appreciated that the integrated part 290 rigidly positions and optically aligns the core 300 of the optical fiber 30 within the optical adapter 12 without the use or need of a housing that is typically disposed around a ferrule and ferrule holder. Accordingly, the optical sub-assembly 10 with the optical adapter 12 and connector 20 provides for compact optical interconnections with fewer components (parts) and less space than typical optical sub-assemblies.

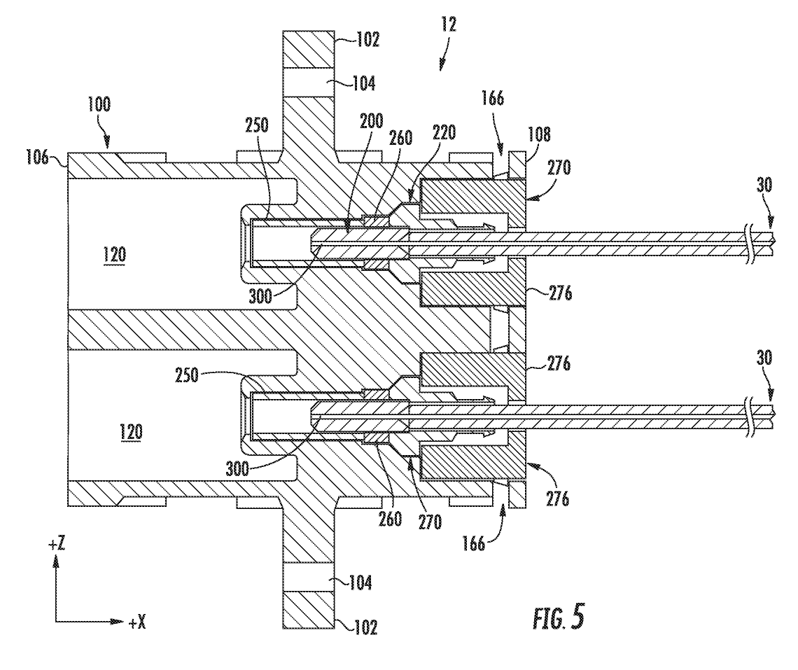

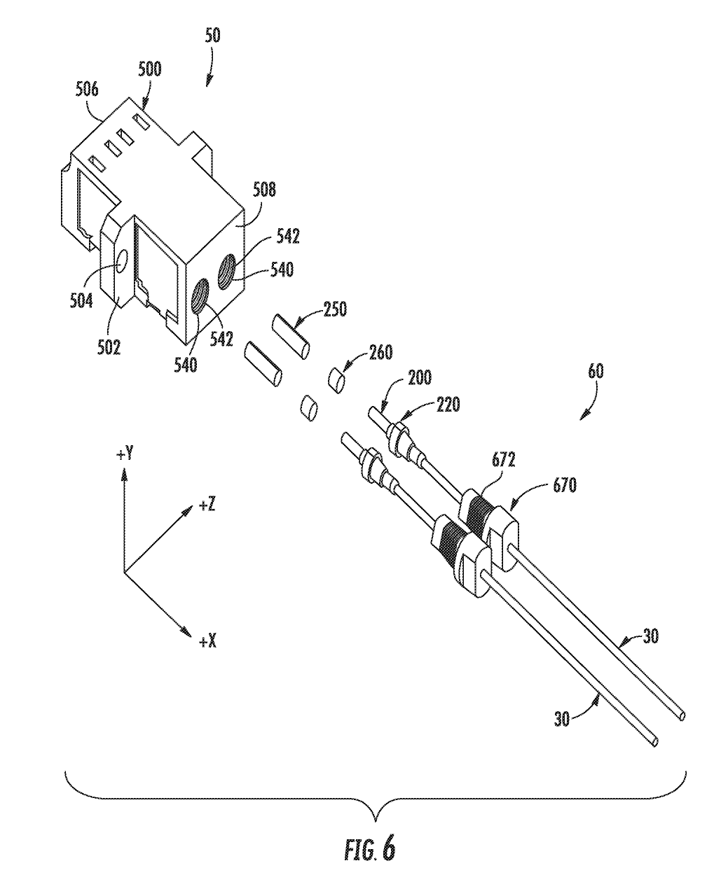

Referring now to FIGS. 6 and 7, another embodiment of an optical sub-assembly is shown. Particularly, an exploded view of an optical sub-assembly 14 comprising an optical adapter 50 and a connector 60 is shown in FIG. 6 and a cross-sectional view of the optical sub-assembly 14 is shown in FIG. 7. The optical adapter 50 includes a main body 500 with a front side 506 and a rear side 508. The main body 500 defines an internal chamber 510 between the front side 506 and rear side 508. One or more flanges 502 extending from the main body 500 with a hole 504 may be included such that the optical adapter 50 can be mounted to a separate structure such as a module (not shown). The connector 60 includes a ferrule 200, a ferrule holder 220 and a rear body 670. An optical fiber 30 can extend through the rear body 670, the ferrule holder 220 and into the ferrule 200. A sleeve 250 may be included, as can a ring 260. It should be appreciated that while FIGS. 6 and 7 depict the main body 500 with two internal chambers 510 and two connectors 60 comprising the ferrule 200, ferrule holder 220 and rear body 270, the disclosure includes optical sub-assemblies with a single internal chamber 510 and connector 60, and optical sub-assemblies with more than two internal chambers 510 and connectors 60.

The internal chamber 510 defined by the main body 500 may include a front internal chamber 520 and a rear internal chamber 540. The rear internal chamber 540 may include a sleeve section 550 and a rear body section 560. A transition section 568 may be included and extend between the sleeve section 550 and the rear body section 560. A locking mechanism to lock the connector 60 within the optical adapter 50 includes internal threads 542 within the rear body section 560 and external threads 672 on the rear body 670. It should be understood that the internal threads 542 are complimentary with the external threads 672 such that the rear body 670 can threadingly engage and advance into the rear body section 560 via rotation of the rear body 670 relative to the rear internal chamber 540 thereby sealing rear body section 560 of the optical adapter 50.

As depicted in FIGS. 6 and 7, the main body 500 may include two internal chambers 540 symmetrically disposed along a longitudinal axis (not shown). While FIG. 7 depicts the front internal chamber 520 having a different shape than the rear internal chamber 540, it should be appreciated that the optical adapter 50 may include a front internal chamber 520 that is symmetric with the rear internal chamber 540 about a transverse axis (not shown).

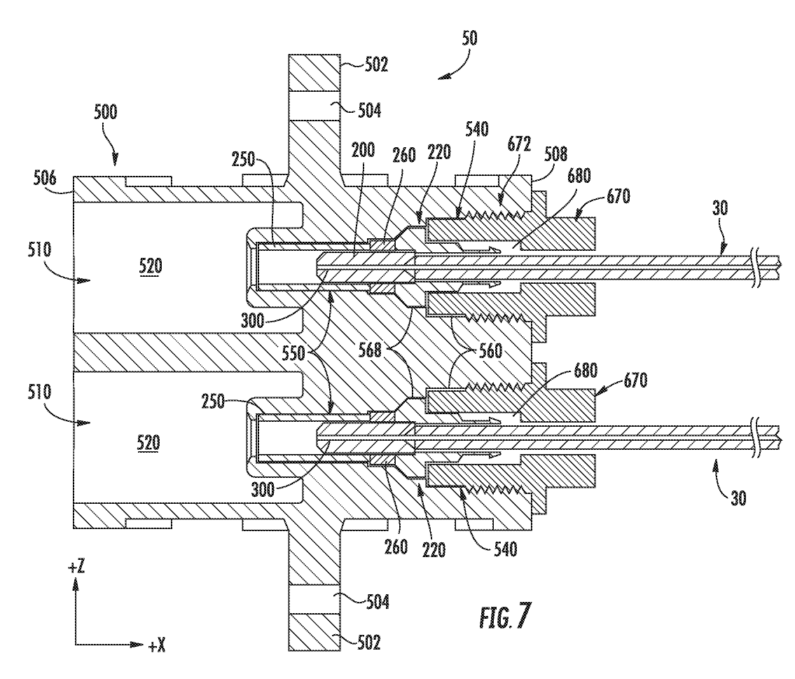

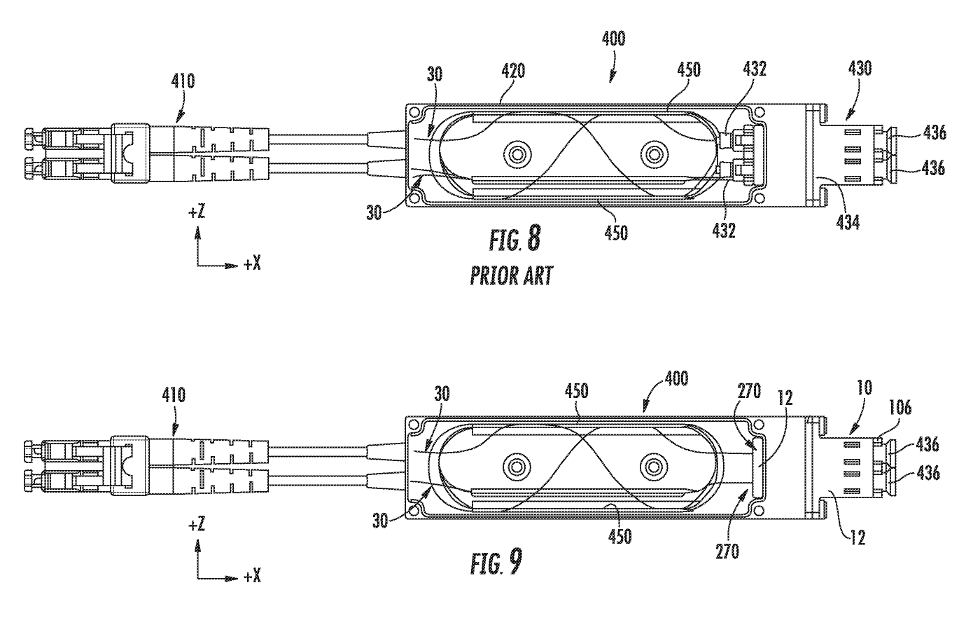

Referring now to FIGS. 8 and 9, an example optical sub-assemblies disclosed herein employed within an optical fiber network is depicted. Particularly, a loopback module 400 using a typical optical sub-assembly 430 is shown in FIG. 8 and the same loopback module 400 using the optical sub-assembly 10 disclosed herein is shown in FIG. 9. The loopback module 400 may be used for testing optical fibers and optical fiber components. The loopback module 400 includes a body 420, an optical fiber input adapter 410 and an optical fiber 30 disposed within the body 420. Electronic components 450 may be disposed in the body 420. The loopback module 400 depicted in FIG. 8 has a typical (prior art) optical sub-assembly 430 attached thereto. The optical sub-assembly 430 includes a pair of connectors 432 disposed in the body 420 and extending into an optical adapter 434. Another pair of connectors 436 extending from the optical adapter 434 are disposed outside of the body 420. The loopback module 400 depicted in FIG. 9 has the optical sub-assembly 10 attached thereto with a pair of connectors 20 (not shown) including the rear bodies 270 disposed in the optical adapter 12 as discussed above. As shown in FIG. 9, the rear bodies 270 do not occupy space within the body 420 and thereby provide more space within the body 420 for additional electronic components 450, optical fiber 30, etc. Also, without the need for a housing within the optical adapter 12, assembly of the optical fibers 30 with the optical sub-assembly 10 can be performed by an individual in less time and with less effort.

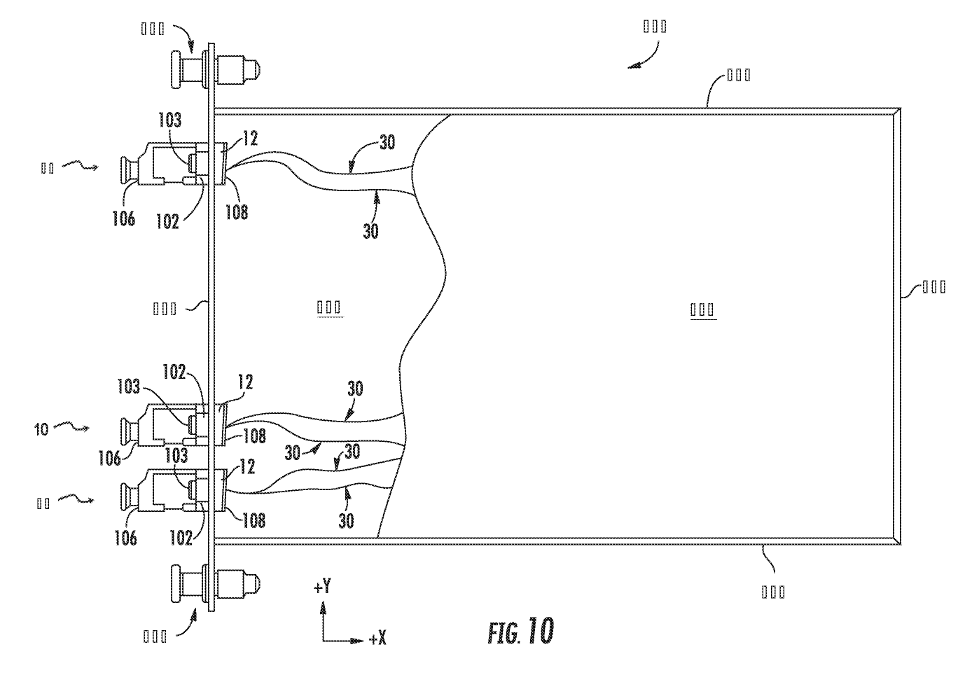

Referring now to FIG. 10, another example of optical sub-assemblies disclosed herein employed within an optical fiber network is depicted. Particularly, a rack module 700 with a plurality of optical sub-assemblies 10 used to provide connections to a plurality of optical fibers 30 is shown in FIG. 10. The rack module 700 includes a front wall 710, a rear wall 712 and a pair of side walls 714 extending between the front wall 710 and the rear wall 712. A bottom panel 716 and a top panel 718 form an interior space within the rack module 700. Also, a pair of fasteners 720 allow the rack module 700 to be attached to a rack (not shown). A side view (Z direction) of the plurality of optical sub-assemblies 10 is shown in FIG. 10. The plurality of optical sub-assemblies 10 are attached and extend through the front wall 710 using the flanges 102 (FIG. 1) and fasteners 103 to mount the optical sub-assemblies 10 the front wall 710. As depicted in FIG. 10, the connectors 20 (not shown) do not extend into the interior space of the rack module 700. Also, with the optical sub-assemblies 10 not requiring a housing, assembly of the optical fibers 30 with the optical sub-assemblies 10 can be performed by an individual in less time and with less effort.

It should be understood while FIGS. 1-10 describe and illustrate an optical sub-assembly with at least one internal chamber that provides for coupling of at least one optical fiber to an electronic device or another optical fiber. The optical sub-assembly disclosed herein does not require a housing and thereby provides an optical adapter with a connector that occupies less space than known optical adapters and connectors. The optical sub-assembly disclosed herein can also be assembled in less time and with less effort given the more efficient or simplistic design of the optical adapter and connector. It should also be appreciated that the optical adapter and connector provide for positioning, e.g. rigid positioning, and alignment, e.g., optical alignment, of an optical fiber without the need or use of a housing and thus a simplified and less costly design are provided.

In various embodiments, a method of assembling one or more optical fibers within an optical sub-assembly is provided. The method includes inserting an optical fiber within a connector that includes a ferrule, a ferrule holder and a rear body. The ferrule has a central bore for a core of the optical fiber to slide into and be positioned within, and the ferrule holder has an internal opening with a ferrule section. The ferrule may be configured to slide into and be positioned within the ferrule holder with an interference fit there between, or in the alternative, the ferrule holder may be overmolded onto the ferrule. The rear body has an optical fiber opening for the optical fiber to slide through and be disposed within. The optical fiber has an exposed core and is fed through the optical fiber opening of the rear body and internal opening of the ferrule holder. The core of the optical fiber is fed into the central bore of the ferrule and held in a fixed position within the central bore relative to the ferrule. The ferrule is pushed into the ferrule holder with an interference fit there between to form an integrated part, or in the alternative, the ferrule holder is overmolded onto the ferrule to form an integrated part. The sleeve, either before the ferrule is pushed into the ferrule holder or after the ferrule is pushed into the ferrule holder, is pushed onto the ferrule with an interference fit there between. The sleeve, ferrule and ferrule holder may form an integrated part. The rear body and the integrated part comprising the ferrule and ferrule holder or the integrated part comprising the ferrule, ferrule holder and sleeve are pushed into an internal chamber of an optical adapter. In embodiments, the optical adapter comprises a main body that defines the internal chamber. The internal chamber may include a front internal chamber and a rear internal chamber. The rear internal chamber may comprise a sleeve section, a rear body section and a transition section extending between the sleeve section and the rear body section. The sleeve section may have an inner diameter that provides an interference fit with the sleeve and the rear body section may have an inner diameter that provides an interference fit with the rear body. The rear body and integrated part are pushed into the rear internal chamber such that the sleeve is disposed within the sleeve section, the ferrule holder is disposed within the transition section and the rear body is disposed into the rear body section. A locking mechanism locks the rear body of the connector within the rear internal chamber and the ferrule, ferrule holder and sleeve rigidly position and optically align the core of the optical fiber within the optical adapter.

The optical fibers discussed herein may be flexible, transparent optical fibers made of glass or plastic. The fibers may function as a waveguide to transmit light between the two ends of the optical fiber. Optical fibers may include a transparent core surrounded by a transparent cladding material with a lower index of refraction. Light may be kept in the core by total internal reflection. Glass optical fibers may comprise silica, but some other materials such as fluorozirconate, fluoroaluminate and chalcogenide glasses, as well as crystalline materials, such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage. These coatings may be UV-cured urethane acrylate composite materials applied to the outside of the optical fiber during the drawing process. The coatings may protect the strands of glass fiber. The optical fiber may comprise an inner primary coating and an outer secondary coating. Optical fiber coatings may be applied in concentric layers.

The optical adapters discussed herein may typically comprise polymer materials such as, but not limited to, polymers, ceramics or metals. The rear body of the connector discussed herein may typically comprise a polymer material, such as, but not limited to, polyetherketone (PEEK), polypropylene (PP), polyvinyledene fluoride (PVDF) and the like. However, other materials of construction of the ferrule are contemplated herein, such as metals, ceramics, or combinations thereof. The ferrules discussed herein may typically comprise a ceramic material, such as, but not limited to, zirconia, alumina, titanium-doped aluminum, glass-filled PPS, or combinations thereof. However, other materials of construction of the ferrule are contemplated herein, such as metals, ceramics, polymers, or combinations thereof. The ferrule holders discussed herein may typically comprise a metal material, such as, but not limited to, steel, stainless. NI-base alloys and the like. However, other materials of construction of the ferrule holder are contemplated herein, such as pure metals, ceramics, polymers, or combinations thereof. The sleeves discussed herein may typically comprise a polymer material, such as, but not limited to, polyetherketone (PEEK), polypropylene (PP), polyvinyledene fluoride (PVDF) and the like. However, other materials of construction of the ferrule are contemplated herein, such as metals, alloys, ceramics, or combinations thereof. The rings discussed herein may typically comprise a metal material, such as, but not limited to, steel, stainless steel, Ni-base alloys and the like. However, other materials of construction of the ferrule holder are contemplated herein, such as pure metals, ceramics, polymers, or combinations thereof.

Unless otherwise expressly stated, it is in no way intended that any methods set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the scope of the disclosure should be construed to include everything within the scope of the appended claims their equivalents.

What is claimed is:

1. An optical sub-assembly, comprising:
an optical adapter comprising a main body defining an internal chamber disposed between a front side and a rear side, the internal chamber comprising a rear internal chamber with a sleeve section and a rear body section;
a connector disposed within the rear internal chamber, the connector comprising a ferrule, a ferrule holder from which the ferrule extends, and a rear body;
a sleeve holding the ferrule; and
an optical fiber extending into the ferrule, wherein:
the ferrule, ferrule holder and sleeve form an integrated part,
the sleeve is disposed in the sleeve section of the rear internal chamber of the main body with an interference fit,
the ferrule holder is disposed in the rear body section of the rear internal chamber, and
the ferrule, ferrule holder, sleeve and rear body position and align the optical fiber within the optical adapter.

2. The optical sub-assembly of claim 1, wherein the rear body disposed within the rear body section of the rear internal chamber has a rear face generally flush with the rear side of the main body.

3. The optical sub-assembly of claim 1, wherein the rear body is a cap covering a rear opening of the rear internal chamber.

4. The optical sub-assembly of claim 1, wherein the rear internal chamber further comprises a transition section extending between the sleeve section and the rear body section, and the ferrule holder is disposed in the transition section and the rear body section.

5. The optical sub-assembly of claim 4, wherein the ferrule is disposed within the sleeve section and the transition section of the rear internal chamber.

6. The optical sub-assembly of claim 1, further comprising a locking mechanism configured to lock the connector to the rear internal chamber of the optical adapter.

7. The optical sub-assembly of claim 6, wherein the locking mechanism comprises a locking mechanism slot disposed within a wall of the main body and a locking mechanism lever extending from the rear body, wherein the locking mechanism lever engages the locking mechanism slot when the connector is disposed within the rear internal chamber of the optical adapter.

8. The optical sub-assembly of claim 1, wherein the connector consists of the rear body, ferrule and ferrule holder.

9. The optical sub-assembly of claim 1, wherein the connector consists of the rear body, ferrule, ferrule holder and sleeve.

10. An optical sub-assembly, comprising:
an optical adapter comprising a main body defining a front internal chamber and a rear internal chamber disposed between a front side and a rear side of the main body;
a connector disposed within the rear internal chamber, the connector comprising a ferrule, a ferrule holder and a rear body;
a sleeve disposed within the rear internal chamber; and
an optical fiber extending through the rear body, ferrule holder and into the ferrule,
wherein:
the ferrule, ferrule holder and sleeve form an integrated part configured to position and align the optical fiber within the optical adapter, and
the rear body has a rear face generally flush with the rear side of the main body.

11. The optical sub-assembly of claim 10, wherein the rear internal chamber comprises a sleeve section, a rear body section and a transition section extending between the sleeve section and rear body section.

12. The optical sub-assembly of claim 11, wherein the ferrule and the sleeve are disposed within the sleeve section with an interference fit, the rear body is disposed in the rear body section and the ferrule holder is disposed in the transition section.

13. The optical sub-assembly of claim 12, wherein the ferrule holder is disposed in the transition section and the rear body section.

14. The optical sub-assembly of claim 10, wherein the optical adapter comprises at least two front internal chambers and at least two rear internal chambers disposed between the front side and the rear side of the main body.

15. The optical sub-assembly of claim 14, further comprising at least two connectors such that a connector is disposed in each of the at least two rear internal chambers, wherein each connector comprises a ferrule, a ferrule holder, a sleeve and a rear body.

16. An optical sub-assembly, comprising:
an optical adapter comprising a main body defining a first internal chamber and a second internal chamber disposed between a front side and a rear side, the first internal chamber and the second internal chamber each comprising a first rear internal chamber and a second rear internal chamber, respectively;
a first connector disposed within the first rear internal chamber and a second connector disposed within the second rear internal chamber, the first connector and the second connector each comprising a ferrule, a ferrule holder, a rear body and a sleeve;
a first optical fiber disposed within the rear body, ferrule holder and ferrule of the first connector;
a second optical fiber disposed within the rear body, ferrule holder and ferrule of the second connector;
wherein the ferrule, ferrule holder and sleeve of each of the first connector and the second connector form an integrated part disposed within the main body that positions and aligns the first optical fiber and the second optical fiber within the optical adapter.

17. The optical sub-assembly of claim 16, wherein the first rear internal chamber and the second rear internal chamber each comprise a sleeve section, a rear body section and a transition section extending between the sleeve section and the rear body section.

18. The optical sub-assembly of claim 17, wherein:
the sleeves of the first connector and the second connector are disposed in the sleeve section of the first rear internal chamber and the second rear internal chamber, respectively, with an interference fit;
the rear bodies of the first connector and the second connector are disposed in the rear body sections of the first rear internal chamber and the second rear internal chamber, respectively;
the ferrule holders of the first connector and the second connector are disposed in the sleeve sections, transition sections and rear body sections of the first rear internal chamber and the second rear internal chamber, respectively.

19. The optical sub-assembly of claim 16, wherein:
the rear bodies of the first connector and the second connector each comprise a ferrule holder cavity;
the ferrule holders of the first connector and the second connector are disposed within the ferrule holder cavities of the rear bodies of the first connector and the second connector, respectively.

20. The optical sub-assembly of claim 16, wherein:
the main body of the optical adapter comprises at least two locking mechanism slots and the rear bodies of the first connector and the second connector each comprise a locking mechanism lever;
the locking mechanism levers are engaged with the locking mechanism slots when the rear bodies of the first connector and the second connector are disposed within the first rear internal chamber and the second rear internal chamber, respectively.
